(19) United States
(12) Patent Application Publication
(10) Pub. No.: US 2013/0116971 A1
(43) Pub. Date: May 9, 2013

(54) METHOD FOR GENERATING A SIGNAL FOR A DISTANCE MEASUREMENT AND METHOD AND SYSTEM FOR DISTANCE MEASUREMENT BETWEEN A TRANSMITTER AND A RECEIVER

(71) Applicant: Fraunhofer-Gesellschaft zur Foerderung der angewandten Forschung e.V., Munich (DE)

(72) Inventors: Reiner RETKOWSKI, Erlangen (DE); Andreas EIDLOTH, Erlangen (DE)

(73) Assignee: Fraunhofer-Gesellschaft zur Foerderung der angewandten Forschung e.V., Munich (DE)

(21) Appl. No.: 13/727,764

(22) Filed: Dec. 27, 2012

Related U.S. Application Data
(63) Continuation of application No. PCT/EP2011/060710, filed on Jun. 27, 2011.

(30) Foreign Application Priority Data
Jun. 28, 2010 (DE) 102010030603.7

(51) Int. Cl. G01B 21/16; G06F 15/00

(52) U.S. Cl. CPC G01B 21/16; G06F 15/00
USPC 702/159

(57) ABSTRACT

For generating a signal for distance measurement between a transmitter and a receiver, a sequence of pulses with predetermined respectively different time intervals between individual pulses is generated.

### CROSS-REFERENCE TO RELATED APPLICATIONS

This application is a continuation of copending International Application No. PCT/EP2011/060710, filed Jun. 27, 2011, which is incorporated herein by reference in its entirety, and additionally claims priority from German Application No. DE 102010030603.7, filed Jun. 28, 2010, which is also incorporated herein by reference in its entirety.

### BACKGROUND OF THE INVENTION

Embodiments of the invention relate to a method for generating a signal for distance measurements between a transmitter and a receiver. Further embodiments of the invention relate to a concept for distance measurement between a transmitter and a receiver. Finally, further embodiments of the invention relate to a method for reducing signal superimpositions by reflections in ultra-wide band systems for localization.

The technical literature provides different methods where UWB (ultra-broad band) pulses are time-shifted to encode information into the signal. A known procedure is PPM (pulse position modulation). Thereby, the repetition rate of the pulses is implemented such that the channel has to decay by the next pulse so that no superimpositions of the pulse with reflections of the previous pulse result in the receiver. In communication engineering, this is referred to as intersymbol interference.

However, it is a basic problem that this method can hardly use the advantage of short impulses, since the length of the impulse response in the channel decides when the next pulse can be transmitted and thus determines the maximum pulse rate.

### SUMMARY

According to an embodiment, a method for distance measurement between a transmitter and a receiver may have the steps of: transmitting a signal generated according to a method for generating a signal for distance measurement between a transmitter and a receiver, with a transmitter; the method for generating the signal having the steps of: generating a sequence of pulses with predetermined respectively different time intervals between individual pulses of the sequence, wherein generating the sequence includes: providing a plurality of generated sequences with respectively different time patterns, wherein a time pattern specifies how the time intervals between the individual pulses are set; and selecting a sequence from the plurality of generated sequences in dependence on an ambient condition of a transmitter, receiving the transmitted signal with a receiver; and determining a distance between the transmitter and the receiver based on the received signal that also includes reflections of the transmitted signal that are received at the receiver, wherein the receiver is aware of the signal transmitted by the transmitter, wherein determining the distance includes comparing a signal derived from the received signal with the transmitted signal, and, if the signal derived from the received signal corresponds to the transmitted signal, determining the distance between the transmitter and the receiver based on a time difference between the signal derived from the received signal and the transmitted signal, wherein the method for distance measurement is implemented to obtain the derived signal by windowing the received signal corresponding to a time pattern of the transmitted signal specifying the time intervals between the individual pulses.

According to another embodiment, a system for distance measurement between a transmitter and a receiver may have: a transmitter that is implemented to transmit a signal generated according to a method for generating a signal for distance measurement between a transmitter and a receiver; wherein the method for generating the signal includes: generating a sequence of pulses with predetermined respectively different time intervals between individual pulses of the sequence, wherein generating the sequence includes: providing a plurality of generated sequences with respectively different time patterns, wherein a time pattern specifies how the time intervals between the individual pulses are set; and selecting a sequence from the plurality of generated sequences in dependence on an ambient condition of a transmitter, a receiver that is implemented to receive the transmitted signal; and a signal processing means that is implemented to determine a distance between the transmitter and the receiver based on the received signal that also includes reflections of the transmitted signal, wherein in the system the receiver is aware of the signal transmitted by the transmitter, wherein the signal processing means is implemented to perform, in the step of determining the distance, comparing a signal derived from the received signal with the transmitted signal, and, if the signal derived from the received signal corresponds to the transmitted signal, determining the distance between the transmitter and the receiver based on a time difference between the signal derived from the received signal and the transmitted signal, wherein the system is implemented to obtain the derived signal by windowing the received signal corresponding to a time pattern of the transmitted signal specifying the time intervals between the individual pulses.

Another embodiment may have a computer program having a program code for performing the inventive method when the computer program runs on a computer.

Embodiments of the invention provide a method for generating a signal for distance measurement between a transmitter and a receiver, comprising:

generating a sequence of pulses with predetermined respectively different time intervals between individual pulses of the sequence.

It is the core idea of the present invention that the above stated simplification of the technical realization or the fast release of the channel can be obtained when, during generating a signal for distance measurement between a transmitter and a receiver, a sequence of pulses is generated with predetermined respectively different time intervals between individual pulses of the sequence. Thereby, a large part of the reflection superimpositions in the receiver can be suppressed, which allows a reduction of the sequence length of the signal.

In further embodiments of the invention, the method for generating the signal for distance measurement comprises providing a plurality of generated sequences with respectively different time patterns and/or a different number of pulses, wherein a time pattern specifies how the time intervals between the individual pulses are set, and selecting a sequence from the plurality of generated sequences. Thus, a set of all possible sequences can be generated, from which eventually a suitable sequence can be selected for the signal for distance measurement. Here, selecting the sequence can be performed, for example, in dependence on ambient conditions of the transmitter.

Further embodiments of the invention provide a method for distance measurement between a transmitter and a receiver, comprising:
transmitting an inventive signal with a transmitter;
receiving the transmitted signal with a receiver; and
determining a distance between a transmitter and a receiver based on the received signal and on reflections of the transmitted signal that are received at the receiver.

In further embodiments of the invention, if no valid signal is detected in the receiver for the distance measurement during a predetermined time period, a transmitter can be directed, by returning a signal to the same, to select a signal having a different sequence from the plurality of generated sequences and to transmit the same. Thus, selecting a sequence can be performed dynamically and can be adapted, for example by an adaptive system, to the current ambient conditions.

Further embodiments of the invention provide a system for distance measurement between a transmitter and a receiver, comprising:
a transmitter that is implemented to transmit an inventive signal;
a receiver that is implemented to receive the transmitted signal; and
a signal processing means that is implemented to determine a distance between the transmitter and the receiver based on the received signal and on reflections of the transmitted signal.

### BRIEF DESCRIPTION OF THE DRAWINGS

Embodiments of the present invention will be detailed subsequently referring to the appended drawings, in which:

FIG. 1 is an exemplary graph of an inventive pulse;

FIG. 2 is a schematic illustration of a system for distance measurement between a transmitter and a receiver according to embodiments of the invention;

FIG. 3 is an exemplary graph of a pulse and its reflections as detected in the receiver for defining the decay time of the reflections;

FIG. 4 is a flow diagram of a method for generating a signal for distance measurement according to embodiments of the invention;

FIG. 5 is an exemplary graph of an inventive signal for distance measurement;

FIG. 6 is a flow diagram of a method for distance measurement between a transmitter and a receiver according to embodiments of the invention;

FIG. 7 is an exemplary graph of a received signal for illustrating reflection superimpositions;

FIG. 8 is an exemplary graph of a signal received after windowing the received signal;

FIG. 9 is a flow diagram of a method for generating a signal for distance measurement, further comprising providing a plurality of generated sequences, according to further embodiments of the invention;

FIG. 10 is a flow diagram of a system for distance measurement with a return channel according to further embodiments of the invention; and

FIG. 11 is an exemplary graph of an inventive signal with a sequence length that is reduced compared to conventional technology.

### DETAILED DESCRIPTION OF THE INVENTION

Before the present invention will be discussed in more detail below with respect to the figures, it should be noted that in the following embodiments the same elements or functionally equal elements are provided with the same reference numbers in the figures. Thus, a description of elements having the same reference numbers is mutually inter-exchangeable and/or inter-applicable in the different embodiments.

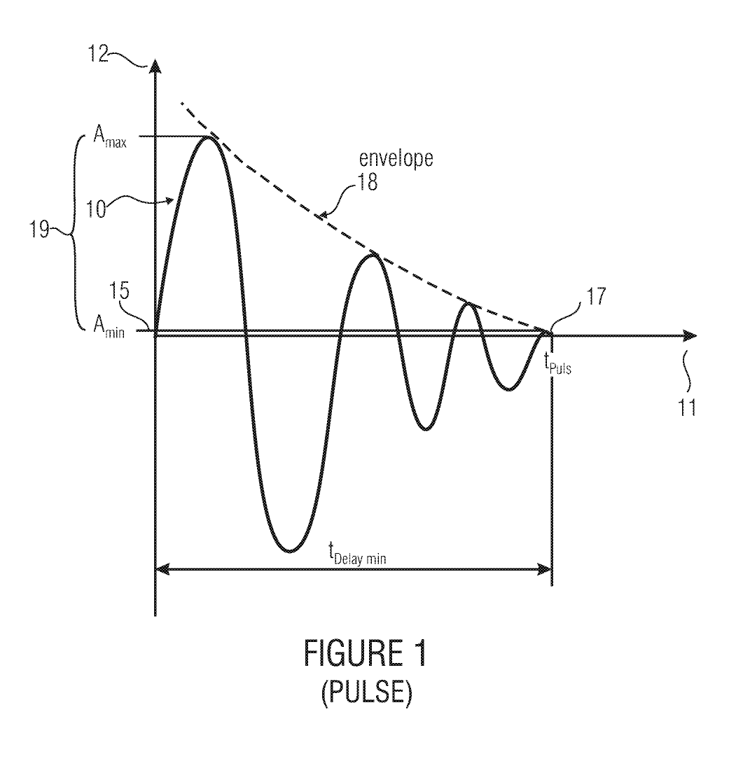

FIG. 1 shows an exemplary graph of an inventive pulse 10. The pulse 10 shown in FIG. 1 can be, for example, a band-limited UWB pulse. In particular, in embodiments, the inventive pulse 10 can be an individual pulse in a sequence of pulses, wherein the sequence can be transmitted as burst-like signal from a transmitter. In FIG. 1, the time is plotted on the horizontal axis 11, while the amplitude of the signal or the pulse is plotted on the vertical axis 12. As shown in FIG. 1, the length tₚᵤₗₛₑ is defined by the time from the beginning 15 of the pulse up to the point 17 where its envelope 18 has decayed to a predetermined amplitude Aₘᵢₙ. Further, the difference 19 between the maximum amplitude of the signal Aₘₐₓ and Aₘᵢₙ can be referred to as dynamic. As will be described in more detail below, in an inventive sequence of pulses, the duration tₚᵤₗₛₑ of the pulse 10 essentially corresponds to a minimum delay t_{Delay min} between the individual pulses of the sequence.

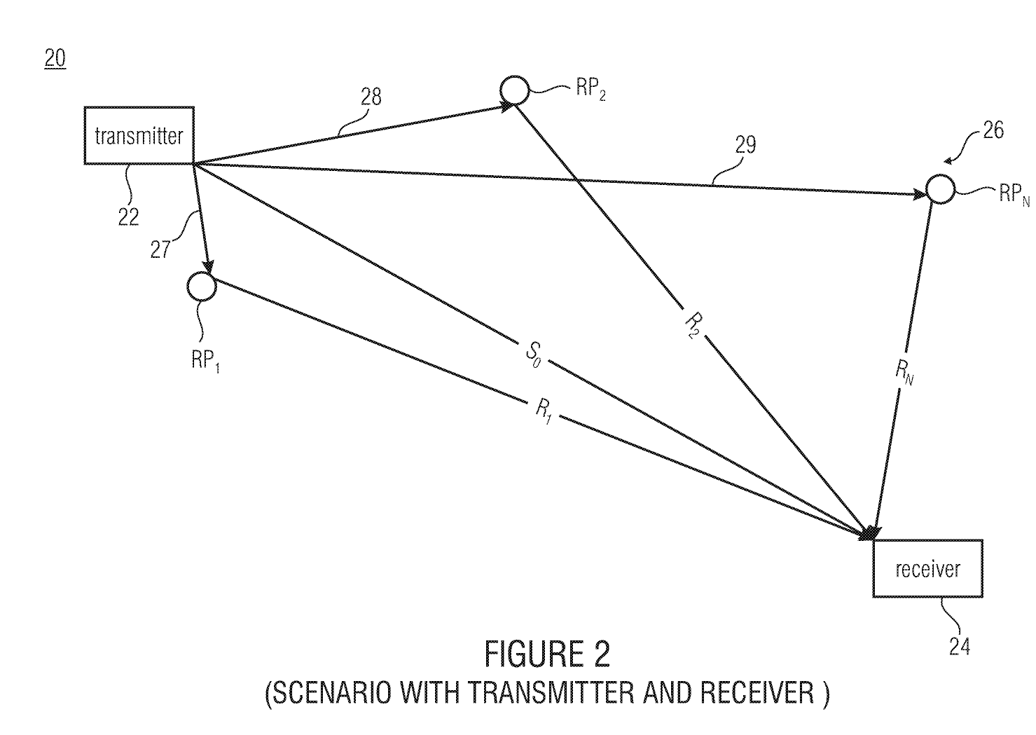

FIG. 2 shows a schematic illustration of a system 20 for distance measurement between a transmitter 22 and a receiver 24 according to embodiments of the invention. As shown exemplarily in FIG. 2, the system 20 comprises, apart from the transmitter 22 and the receiver 24, a plurality 26 of reflection points (RP₁, RP₂, RP_{N}). Here, a signal originating from the transmitter 22 is either transmitted in an unimpeded manner from the transmitter 22 to the receiver 24 (signal S₀) or reflected at the respective reflection points 26 RP₁, RP₂, . . . , RP_{N}, so that the reflected signal or reflections R₁, R₂, . . . , R_{N} arrive at the receiver 24. In particular, the reflection points 26 can be those parts of reflection planes in an environment of the transmitter 22 where the signal originating from the transmitter 22 is respectively reflected. Here, the environment of the transmitter 22 is characterized by different spatial intervals of the reflection points or reflection planes from the transmitter 22, as indicated exemplarily in FIG. 2 by arrows 27, 28, 29 having different lengths.

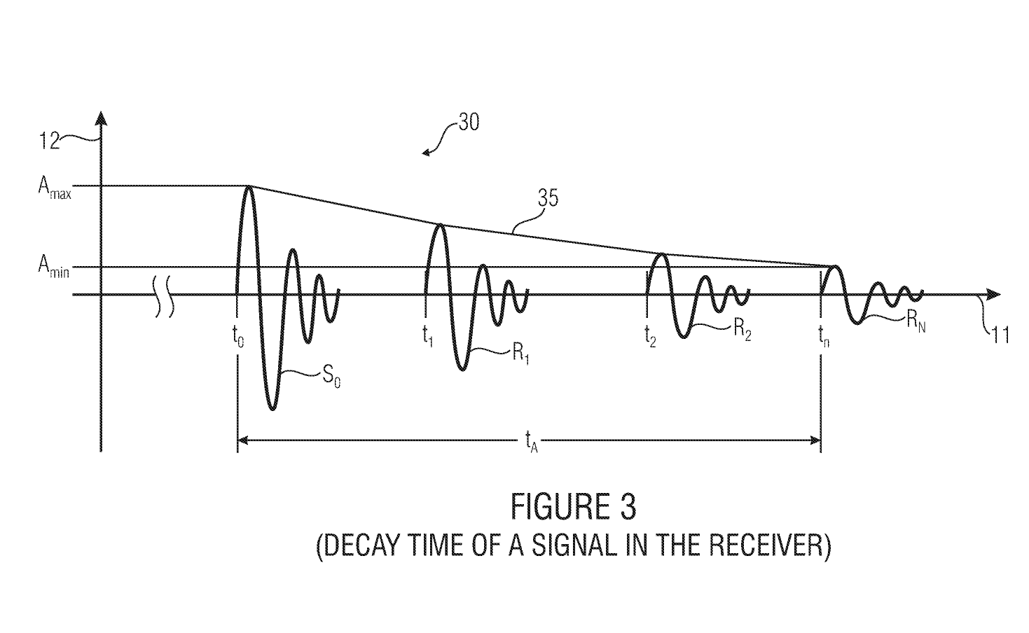

FIG. 3 shows an exemplary graph of a pulse and its reflections 30 in the receiver 24 for defining the decay time of the reflections. If a scenario according to FIG. 2 having a transmitter 22, a receiver 24 and 1 to N reflection points 26 is assumed, the decay time of the reflections at the receiver 24 will result from the time difference t_{A} between the first arrival time t₀ of pulse S₀ and time tₙ, when reflections R₁, R₂, . . . , R_{N} have decayed to Aₘᵢₙ, as illustrated exemplarily by course 35. According to conventional technology, up to now, this period (t_{A}) is kept free before the next pulse is transmitted.

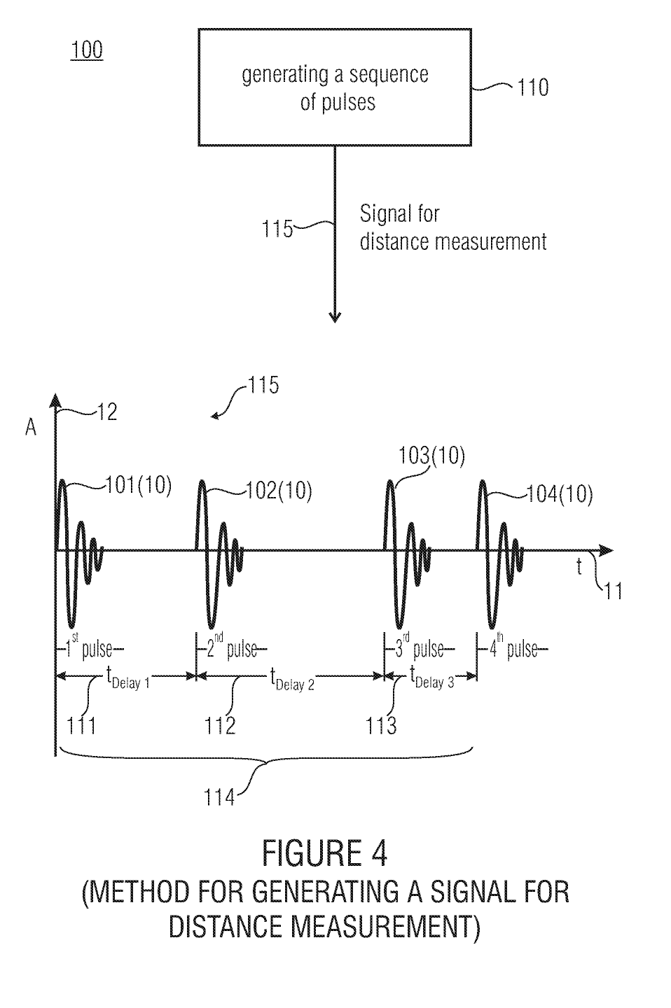

FIG. 4 shows a flow diagram of a method 100 for generating a signal 115 for distance measurement between a transmitter 22 and a receiver 24 according to embodiments of the invention. As shown in FIG. 4, the method 100 comprises generating (step 110) of a sequence 115 of pulses having predetermined respectively different time intervals 111, 112, 113 between individual pulses 101, 102, 103, 104 of the sequence.

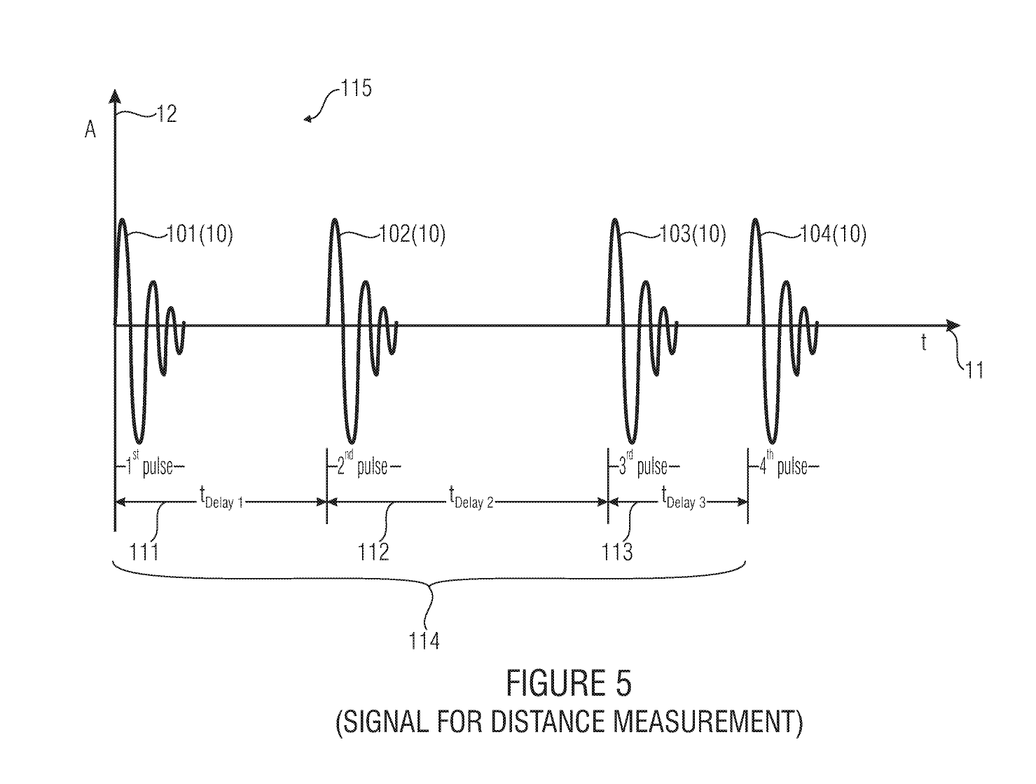

FIG. 5 shows an exemplary graph of the inventive signal 115 shown in FIG. 4 in enlarged view. Here, the individual pulses 101, 102, 103, 104 of the sequence 115 are each referred to by “first pulse”, “second pulse”, “third pulse” and “fourth pulse”, while the different time intervals 111, 112, 113 are each referred to by “t_{Delay2}” and “t_{Delay3}”. In particular, in embodiments of the invention, the generated sequence 115 can be a sequence of equal pulses. This means each pulse 101, 102, 103, 104 has essentially the same course or the same pulse period and dynamic. Further, in further embodiments of the invention, each pulse 101, 102, 103, 104 of the sequence 115 can essentially correspond to the pulse 10 shown in FIG. 1 and can hence be, for example, a band-limited UWB pulse. As can be seen in FIG. 5, the time intervals 111, 112, 113 between the individual pulses 101, 102, 103, 104 are each different. In particular interval 112 is larger than interval 111, while interval 113 is smaller than intervals 111 and 112. The entirety of all time intervals 111, 112, 113 defines a time pattern 114 of sequence 115.

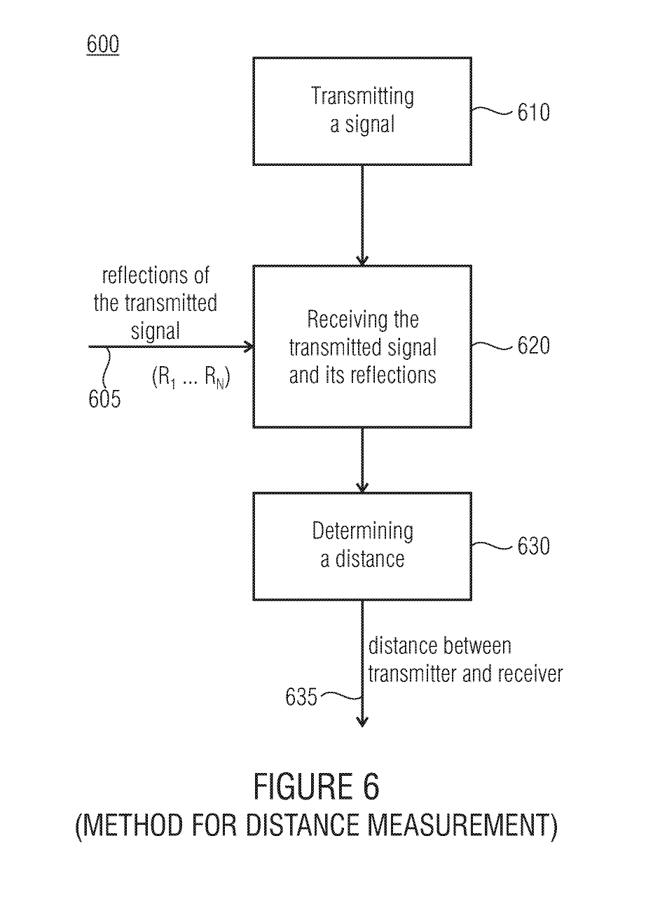

FIG. 6 shows a flow diagram of a method 600 for distance measurement between a transmitter and a receiver according to embodiments of the invention. In particular, method 600 comprises, for example, the following steps. First, an inventive signal, such as the signal 115 for distance measurement, is transmitted with a transmitter (step 610). Then, the transmitted signal and its reflections 605 are received with the receiver (step 620). Finally, a distance 635 between the transmitter and the receiver is determined based on the received signal and its reflections 605 (step 630).

With reference to FIG. 5, the signal described herein is now composed of pulses 101, 102, 103, 104 resulting in a transmit sequence Seqₜᵣₐₙₛₘᵢₜₜₑᵣ in previously defined diffent intervals 111, 112, 113 (t_{Delay1} to t_{DelayN}). In FIG. 5, such a sequence is illustrated exemplarily with four pulses. Here, it is particularly to be aimed for that all pulse intervals are so different that reflections originating from a body irradiated by the transmitter (scenario with transmitter and receiver of FIG. 2) form only few or no superimpositions with pulses of the original sequence.

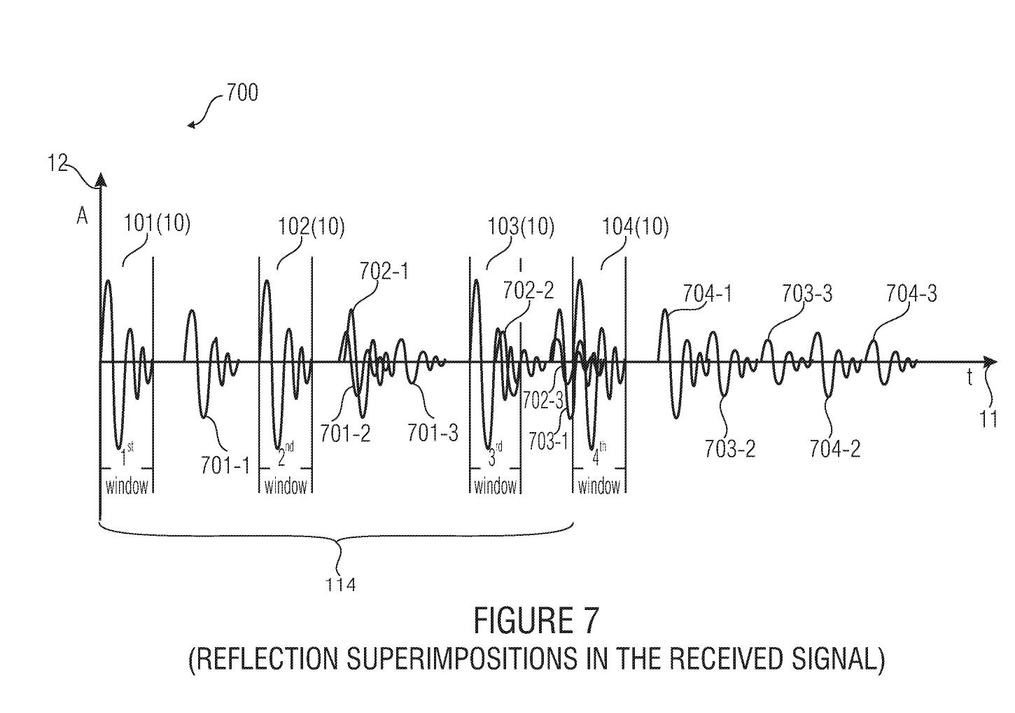

FIG. 7 shows an exemplary graph of a received signal 700 for illustrating reflection superimpositions. In particular, FIG. 7 shows, for illustration purposes, a superimposition of the sequence of FIG. 5 with the reflections of FIG. 3. As shown in FIG. 7, the received signal 700 comprises pulses 101, 102, 103, 104 with the time pattern 114. Further, in the received signal 700, reflections allocated to these pulses 101, 102, 103, 104 can be detected. In embodiments, the first pulse 101, the second pulse 102, the third pulse 103 and the fourth pulse 104 each comprise allocated first reflections 701-1, 702-1, 703-1, second reflections 701-2, 702-2, 703-2, third reflections 701-3, 702-3, 703-3 and fourth reflections 701-4, 702-4, 704-4. Here, the second reflection 702-2 of the second pulse 102 and the third pulse 103 or the first reflection 703-1 of the third pulse 103 and the third reflection 702-3 of the second pulse 102 and the fourth pulse 104 are partly superimposed.

In further embodiments of the invention, the receiver knows the signal transmitted by the transmitter, for example the signal 115 of FIG. 5. In particular, determining (step 630) the distance comprises comparing a signal 800 derived from the received signal 700 with the transmitted signal 115 and, if the signal 800 derived from the received signal corresponds to the transmitted signal 115, determining the distance 635 between the transmitter and the receiver based on a time difference between the signal 800 derived from the received signal and the transmitted signal 115.

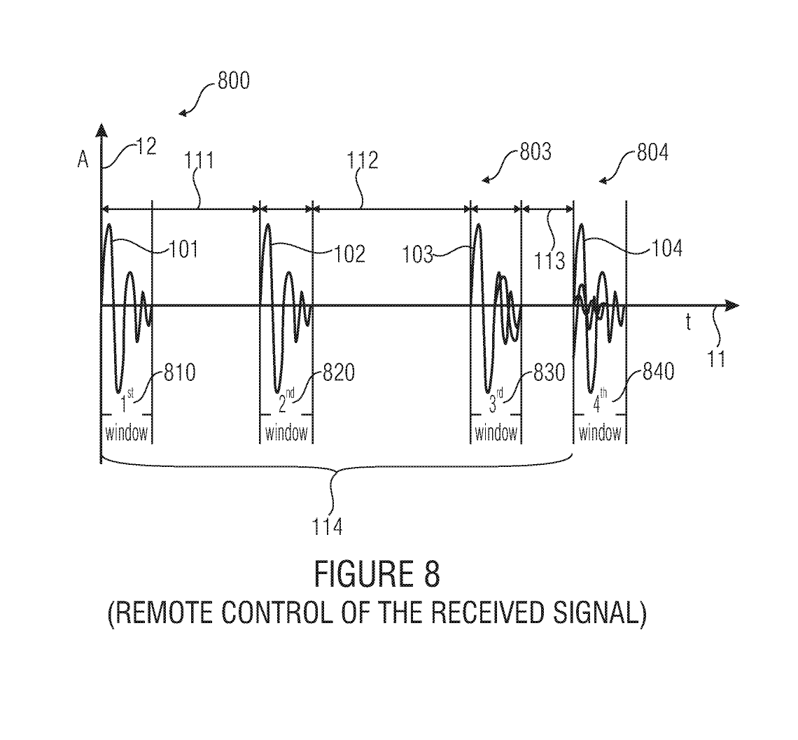

As shown in FIG. 8, in further embodiments of the invention, the derived signal 800 can be obtained by windowing the received signal 700 according to a time pattern 114 of the transmitted signal 115 specifying the time intervals 111, 112, 113 between the individual pulses 101, 102, 103, 104.

FIG. 8 shows an exemplary graph of a signal 800 obtained after windowing the received signal 700. In particular, FIG. 8 shows a first window 810, second window 820, a third window 830 and a fourth window 840, wherein windows 810, 820, 830, 840 each comprise the time intervals 111, 112, 113 in the time pattern 114. Further, FIG. 8 shows partly overlapping pulses 803 and 804 in the third window 830 or the fourth window 840.

Finally, in further embodiments, comparing the signal 800 derived from the received signal 700 can be performed with the transmitted signal 115 by means of a correlation.

In other words, the receiver knows the transmit sequence and looks for the same by examining only those intervals in the time intervals t_{Delay} in which the transmit sequence pulses exist. By this windowing in the receiver, part of the reflections is decayed. A receive sequence Seq_{receiver} results, consisting of transmit pulses which are partly superimposed as exemplarily shown in FIG. 8.

Now, the receiver evaluates the sequence Seq_{receiver} by searching for a correspondence with the transmit sequence Seqₜᵣₐₙₛₘᵢₜₜₑᵣ by an appropriate method, such as correlation. Thereby, the time interval used for generating the sequence Seq_{receiver} is shifted, for example, until the evaluation in the receiver results in a large correspondence with the transmit sequence. Thereby, the windows can be weighted with a different significance. In signal 800, for example, windows 810 and 820 are to be weighted with a higher significance than windows 830 and 840.

If the correspondence between Seqₜᵣₐₙₛₘᵢₜₜₑᵣ and Seq_{receiver} is detected, finally, the distance between transmitter and receiver can be calculated from the run time of the signal.

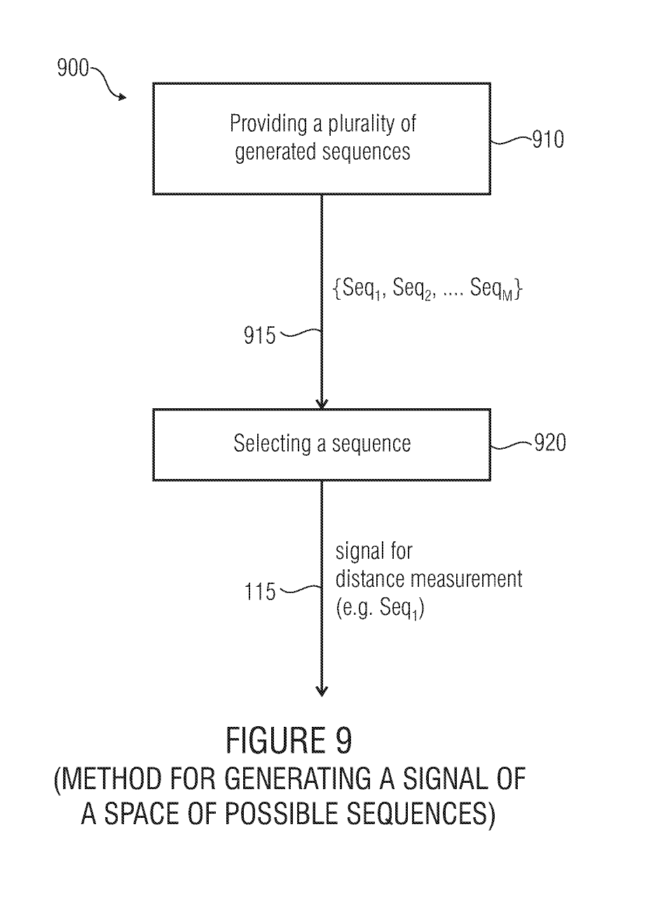

FIG. 9 shows a flow diagram of a method 900 for generating a signal 115 for distance measurement comprising providing 910 a plurality 915 of generated sequences according to further embodiments of the invention. As shown in FIG. 9, in the method 900, first, a plurality 915 of generated sequences with respectively different time patterns and/or a different number of pulses is provided (step 910). Here, a time pattern, such as the time pattern 114 shown in FIG. 5, specifies how the time intervals 111, 112, 113 between the individual pulses 101, 102, 103, 104 are set. In FIG. 9, the plurality 915 of generated sequences is indicated by {Seq₁, Seq₂, . . . Seq_{M}}, wherein {. . . } refers to a set and M refers to the number of generated sequences. Then, a sequence (e.g., Seq₁) is selected from the plurality 915 of generated sequences (step 920). Finally, this results in the signal 115 for distance measurement.

In further embodiments of the invention, selecting 920 the sequence can be performed in dependence on ambient conditions of a transmitter. In particular, the ambient conditions can be given by a spatial distance of the transmitter to a reflection plane (see FIG. 2).

In further embodiments of the invention, the method 100; 900 further comprises attaching a pulse sequence to the generated sequence for transmitting payload data. Here, the payload data can be encoded according to the common principles of communication engineering.

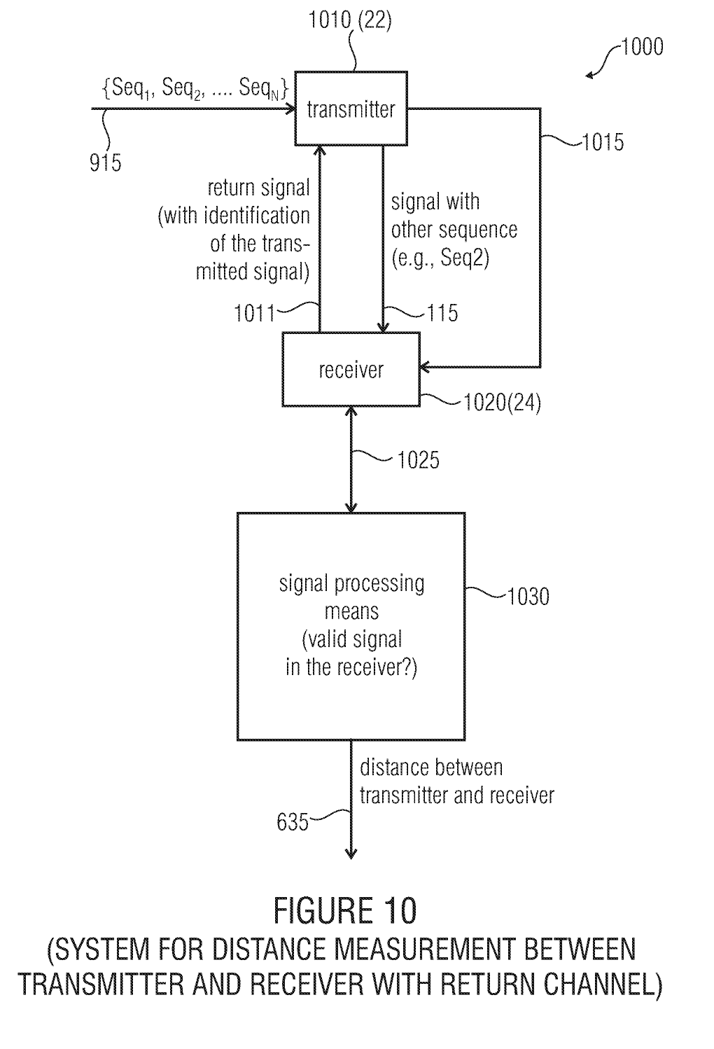

FIG. 10 shows a flow diagram of the systems 1000 for distance measurement between a transmitter and a receiver with a return channel according to further embodiments of the invention. The system 1000 comprises a transmitter 1010, receiver 1020 and a signal processing means 1030. Here, the transmitter 1010 of FIG. 10 corresponds essentially to the transmitter 22 of FIG. 2, while the receiver 1020 of FIG. 10 essentially corresponds to the receiver 24 of FIG. 2. The transmitter 1010 is implemented to transmit an inventive signal 115. Further, the receiver 1020 is implemented to receive the transmitted signal. Finally, the signal processing means 1030 is implemented to determine a distance 635 between transmitter 1010 and receiver 1020 based on the received signal and reflections of the transmitted signal. As shown in FIG. 10, the transmitter 1010 has the option to access the plurality 915 or the set of sequences {Seq₁, Seq₂, . . . Seq_{M}}.

With reference to FIG. 10, the method 900 shown in FIG. 9 comprises, for example, the following step. If during a predetermined time period no valid signal is detected in the receiver 1020 for distance measurement, a signal 1011 can be returned to the transmitter 1010. Here, the returned signal 1011 can comprise information on non-detection of a signal valid for distance measurement and an identification of the transmitted signal 115. By the return signal 1011, the transmitter 1010 can be directed to select a signal 1015 having a different sequence (e.g., Seq₂) from the plurality 915 of generated sequences and to transmit the same. In embodiments of the invention, the signal processing means 1030 that is connected to the receiver 1020 (double arrow 1025) checks whether a valid signal exists in the receiver 1020 for distance measurement. This is indicated in block 1030 by “valid signal in the receiver?”. Finally, the signal processing means 1030 can be implemented to determine the distance 635 between the transmitter 1010 and the receiver 1020 based on a valid signal, such as the signal 1015 with the other sequence (e.g., Seq₂).

In further embodiments of the invention, the other sequence of the signal 1015 comprises a suitable time pattern and/or a suitable number of pulses with respect to received reflection superimpositions. Here, a suitable sequence characteristic should be such that the reflection superimpositions occur in as little windows of the received signal as possible, as shown exemplarily in FIG. 7. As described above, the distance 635 can finally be determined from a time difference.

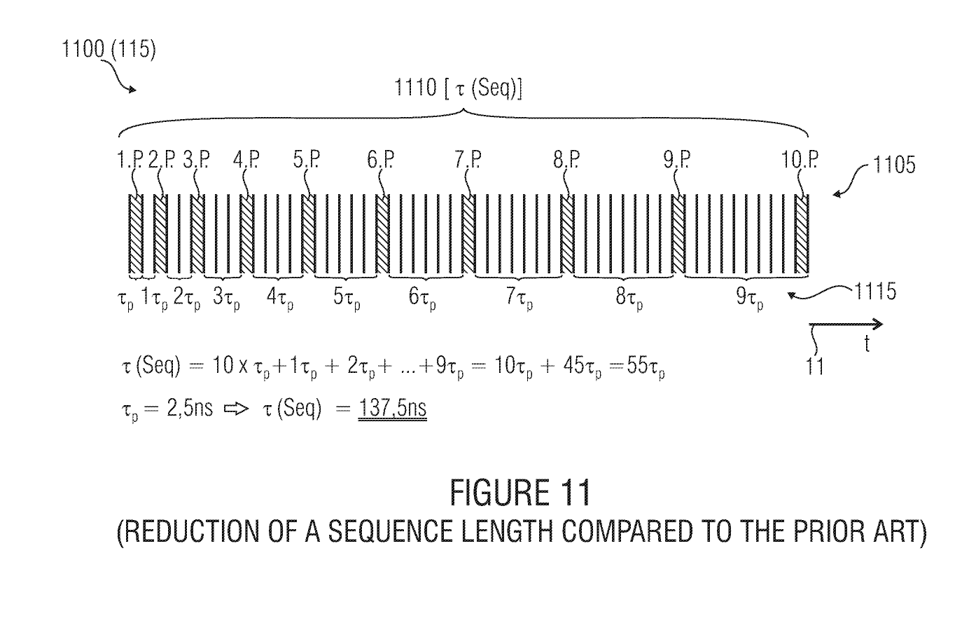

FIG. 11 shows an exemplary graph of an inventive signal 1100 with a sequence length that is reduced compared to conventional technology. The signal 1100 shown in FIG. 11 essentially corresponds to the signal 115 of FIG. 5, wherein the signals 1100; 115, however, comprise a different number of pulses. In particular, signal 1100 consists, for example, of 10 pulses while signal 115 consists, for example, only of four pulses. In FIG. 11, the pulses 1105 of a sequence 1100 are illustrated as shaded portions, each indicated by “1.P.” to “10.P.”. In embodiments, each of these pulses 1105 has the same pulse length τ_{P}, essentially corresponding to the length tₚᵤₗₛₑ or t_{Delay min} of the pulse 10 shown in FIG. 1. Further, the time intervals 1115 between the individual pulses of the sequence 1100 increase each by a pulse length τ_{P} from 1*τ_{P} to 9*τ_{P}. Thus, in the embodiment of FIG. 11, an overall length 1110 of the sequence of τ(Seq)=55*τ_{P} results. This corresponds, for example, at a minimum pulse length of τ_{P}=2.5 ns to a sequence length 1110 of τ(Seq)=137.5 ns.

An advantage of the present system will be illustrated below with reference to the embodiment of FIG. 11. When realizing the system, the burst-like signal of a transmitter or a sequence is composed of band-limited pulses having a time interval t -Delay to one another, which is at least as great as the time period tₚᵤₗₛₑ of the band-limited signal (see FIG. 1).

A distance between individual pulses of the sequence that is as short as possible is important, since the thermal instability of necessitated delay members in a signal processing means becomes larger with increasing run length. If one tries to correlate a respective signal in the receiver, the result will be significantly influenced by the temperature of the transmitter. Further, it has to be stated that delay members having a great run time are hard to realize at the bandwidth necessitated for UWB, and would result in a spatial expansion for a miniature transmitter that is no longer acceptable.

Further, fast release of the channel is important, since in localization technology, frequently many different transmitters are necessitated to monitor a large number of persons or goods. Here, the number of allowable transmitters of a system results from the following relation:
Number of transmitters=1/(sequence length[s]*
Number of sequences per transmitter per second [1/s]).

Here, the sequence length includes, a decay time of the channels or the impulse response of the channel estimated in advance.

If, in embodiments, a square-wave pulse of the length of less than 100 ps is generated and subsequently band-pass filtered to meet the band specification, a wave form results which has typically decayed after approximately 2.5 ns. In FIG. 1 this corresponds, for example, to a decay time of tₚᵤₗₛₑ=2.5 ns of the pulse 10.

In a system where the next pulse may only be transmitted after the decay time of the channel, now, a break of approximately 60 ns would follow. Here, the decay time of the channel corresponds, for example, to the time difference t_{A}=60 ns of the signal 30 in FIG. 3. Thus, the sequence would result from a sequence of pulses at an interval of 60 ns. If the sequence consists, for example, of only 10 pulses in order to be able to differentiate a sufficient number of transmitters, a sequence length of 600 ns results. Therefore, regulation mechanisms are necessitated to compensate for thermal variations of the pulse intervals.

In contrary to this, in the system described herein (FIG. 11), a sequence of ten pulses having different intervals in the raster tₚᵤₗₛₑ (or τ_{P}) and a pulse interval t_{Delay min} of tₚᵤₗₛₑ as described above, necessitates only 55*tₚᵤₗₛₑ=137.5 ns. The useful upper limit of the intervals is obtained when the longest interval is greater than the decay time of the channel. Thus, according to the above relationship, with a number of, for example, 10 pulses, apart from the advantage of shorter and hence thermally more stable time members, at least a quadruplication of the number of allowable transmitters of the system results.

The present invention is also advantageous in that in the raster used in this embodiment of time intervals having the length tₚᵤₗₛₑ=2.5 ns during a speed of movement of the electromagnetic wave of approximately 30 cm per 1 ns, reflection planes at a distance of m *75 cm with m=[1, 2, 3, . . . n] to the transmitter, can still be resolved and evaluated in the receiver.

While some aspects have been described in the context of an apparatus, it is obvious that these aspects also represent a description of the respective method, such that a block or a device of an apparatus can also be seen as a respective method step or as a feature of a method step. Analogously, aspects that have been described in the context of or as a method step also represent a description of a respective block or detail or feature of a respective apparatus.

Depending on specific implementation requirements, embodiments of the invention can be implemented in hardware or in software. The implementation can be made by using a digital memory medium, for example a floppy disk, a DVD, a blue ray disk, a CD, a ROM, PROM, a EPROM, A EEPROM or a flash memory, a hard disk or any other magnetic or optic memory on which electronically readable control signals are stored, that can operate or cooperate with a programmable computer system such that the respective method is performed.

Generally, embodiments of the present invention can be implemented as a computer program product having a program code, wherein the program code is effective to perform one of the methods when the computer program code runs on a computer. The program code can, for example, also be stored on a machine-readable carrier.

Other embodiments comprise the computer program for performing one of the methods described herein, wherein the computer program is stored on a machine-readable carrier.

In other words, an embodiment of the inventive method is a computer program comprising a program code for performing one of the methods described herein, when the computer program runs on a computer. A further embodiment of the inventive method is a data carrier (or a digital memory medium or a computer readable medium) on which a computer program for performing once the methods described herein is recorded.

Thus, another embodiment of the inventive method is a data stream or a sequence of signals representing the computer program for performing one of the methods described herein. The data stream or the sequence of signals can be configured, for example, to be transferred via a data communication connection, for example via the internet.

Further embodiments comprise a processing means, for example computer or programmable logic device that is configured or adapted to perform one of the methods described herein.

A further embodiment comprises a computer on which the computer program for performing one of the methods described herein is installed.

In some embodiments, a programmable logic device, e.g., a FPGA (field programmable gate array) can be used to perform some or all functionalities of the method described herein. In some embodiments, a field programmable gate array can operate with a microprocessor to perform one of the methods described herein. Generally, in some embodiments, the methods are performed by means of any hardware device. This can be a universally usable hardware, such as a computer processor (CPU) or hardware specific for the method, such as an ASIC.

The above-described embodiment merely presents an illustration of the principles of the present invention. It is obvious that modifications and variations of the arrangements and details described herein will be obvious for other persons skilled in the art. Thus, it is intended that the invention is merely limited by the scope of the following claims and not by the specific details that have been presented herein based on the description and the discussion of the embodiments.

In summary, embodiments of the present invention provide a concept by which signal superimpositions by reflections in UWB systems for localization can be reduced. Thus, the disadvantage that transmitted signals frequently become useless for the receiver units in localization technology, since the signals are reflected at a plurality of planes and the reflections superimpose the original signal, can be avoided. For this, the technology described herein uses different time intervals of the ultra-wide band pulses to one another to keep the proportion of losses by reflections included in a signal sequence as low as possible, such that decoding in the receiver is still possible.

Above this, depending on the ambient conditions, it can be advantageous to optimize the system. For this, there is the option to vary the intervals of the pulses to one another in a system or to change the number of pulses in a sequence. Changing the pulse intervals can be performed dynamically and can be adapted to the current ambient conditions, for example by an adaptive system. For this, as described above, a return channel from the receiver to the transmitter is necessitated. Due to the option to generate many different sequences as regards to length and pulse interval, a significant number of different transmitters can be used. Finally, a pulse sequence for transmitting payload data can be attached to the sequence of the transmitter, which can be encoded according to the conventional principles of communication engineering.

While this invention has been described in terms of several advantageous embodiments, there are alterations, permutations, and equivalents which fall within the scope of this invention. It should also be noted that there are many alternative ways of implementing the methods and compositions of the present invention. It is therefore intended that the following appended claims be interpreted as including all such alterations, permutations, and equivalents as fall within the true spirit and scope of the present invention.

1. A method for distance measurement between a transmitter and a receiver, comprising:
transmitting a signal generated according to a method for generating a signal for distance measurement between a transmitter and a receiver, with a transmitter;
the method for generating the signal comprising:
generating a sequence of pulses with predetermined respectively different time intervals between individual pulses of the sequence,
wherein generating the sequence comprises:
providing a plurality of generated sequences with respectively different time patterns, wherein a time pattern specifies how the time intervals between the individual pulses are set; and
selecting a sequence from the plurality of generated sequences in dependence on an ambient condition of a transmitter,
receiving the transmitted signal with a receiver; and
determining a distance between the transmitter and the receiver based on the received signal that also comprises reflections of the transmitted signal that are received at the receiver,
wherein the receiver is aware of the signal transmitted by the transmitter,
wherein determining the distance comprises comparing a signal derived from the received signal with the transmitted signal, and, if the signal derived from the received signal corresponds to the transmitted signal, determining the distance between the transmitter and the receiver based on a time difference between the signal derived from the received signal and the transmitted signal,
wherein the method for distance measurement is implemented to acquire the derived signal by windowing the received signal corresponding to a time pattern of the transmitted signal specifying the time intervals between the individual pulses.

2. The method according to claim 1,
wherein generating the sequence comprises providing a plurality of generated sequences with respectively different time patterns and a different number of pulses.

3. The method according to claim 1, wherein the method for generating the signal further comprises:
attaching a pulse sequence for transmitting payload data to the generated sequence.

4. The method according to claim 1, wherein in the method for generating the sequence the generated sequence is a sequence of equal pulses.

5. The method according to claim 1, wherein in the method for generating the sequence each pulse of the generated sequence is a band-limited pulse.

6. The method according to claim 1, wherein in the method for generating the sequence each pulse of the generated sequence is an UWB (Ultra Wide Band) pulse.

7. The method according to claim 1, wherein comparing the signal derived from the received signal with the transmitted signal is performed by means of a correlation.

8. The method according to claim 1, further comprising:
if during a predetermined time period no valid signal is detected in the receiver for the distance measurement,
returning a signal to the to the transmitter comprising information on non-detection of a signal valid for distance measurement and an identification of the transmitted signal, such that the transmitter is directed to select a signal comprising a different sequence from the plurality of generated sequences and to transmit the same.

9. A system for distance measurement between a transmitter and a receiver, comprising:
a transmitter that is implemented to transmit a signal generated according to a method for generating a signal for distance measurement between a transmitter and a receiver;
wherein the method for generating the signal comprises:
generating a sequence of pulses with predetermined respectively different time intervals between individual pulses of the sequence,
wherein generating the sequence comprises:
providing a plurality of generated sequences with respectively different time patterns, wherein a time pattern specifies how the time intervals between the individual pulses are set; and
selecting a sequence from the plurality of generated sequences in dependence on an ambient condition of a transmitter,
a receiver that is implemented to receive the transmitted signal; and
a signal processor that is implemented to determine a distance between the transmitter and the receiver based on the received signal that also comprises reflections of the transmitted signal,
wherein in the system the receiver is aware of the signal transmitted by the transmitter,
wherein the signal processor is implemented to perform, in the step of determining the distance, comparing a signal derived from the received signal with the transmitted signal, and, if the signal derived from the received signal corresponds to the transmitted signal, determining the distance between the transmitter and the receiver based on a time difference between the signal derived from the received signal and the transmitted signal,
wherein the system is implemented to acquire the derived signal by windowing the received signal corresponding to a time pattern of the transmitted signal specifying the time intervals between the individual pulses.

10. The system according to claim 9,
wherein generating the sequence comprises providing a plurality of generated sequences with respectively different time patterns and a different number of pulses.

11. The system according to claim 9, wherein the method for generating the signal further comprises:
attaching a pulse sequence for transmitting payload data to the generated sequence.

12. The system according to claim 9, wherein in the method for generating the signal the generated sequence is a sequence of equal pulses.

13. The system according to claim 9, wherein in the method for generating the signal each pulse of the generated sequence is a band-limited pulse.

14. The system according to claim 9, wherein in the method for generating the signal each pulse of the generated sequence is an UWB (Ultra Wide Band) pulse.

15. A non-transitory computer readable medium including a computer program comprising a program code for performing, when the computer program runs on a computer, the method for distance measurement between a transmitter and a receiver, the method comprising:
transmitting a signal generated according to a method for generating a signal for distance measurement between a transmitter and a receiver, with a transmitter;
the method for generating the signal comprising:
generating a sequence of pulses with predetermined respectively different time intervals between individual pulses of the sequence,
wherein generating the sequence comprises:
providing a plurality of generated sequences with respectively different time patterns, wherein a time pattern specifies how the time intervals between the individual pulses are set; and
selecting a sequence from the plurality of generated sequences in dependence on an ambient condition of a transmitter,
receiving the transmitted signal with a receiver; and
determining a distance between the transmitter and the receiver based on the received signal that also comprises reflections of the transmitted signal that are received at the receiver,
wherein the receiver is aware of the signal transmitted by the transmitter,
wherein determining the distance comprises comparing a signal derived from the received signal with the transmitted signal, and, if the signal derived from the received signal corresponds to the transmitted signal, determining the distance between the transmitter and the receiver based on a time difference between the signal derived from the received signal and the transmitted signal,
wherein the method for distance measurement is implemented to acquire the derived signal by windowing the received signal corresponding to a time pattern of the transmitted signal specifying the time intervals between the individual pulses.
